(19) United States
(12) Patent Application Publication
(10) Pub. No.: US 2026/0304440 A1
(43) Pub. Date: Oct. 1, 2026

(54) METHOD AND APPARATUS FOR DCI PAYLOAD SIZE DETERMINATION

(71) Applicant: LENOVO (BEIJING) LIMITED, Beijing (CN)

(72) Inventor: Haipeng LEI, Beijing (CN)

(21) Appl. No.: 19/476,980

(22) PCT Filed: Nov. 3, 2023
(86) PCT No.: PCT/CN2023/129668

§ 371 Date: Oct. 20, 2025

(51) Int. Cl. H04W 72/231; H04W 72/0457; H04W 72/12

(52) U.S. Cl. CPC H04W 72/231; H04W 72/0457; H04W 72/12

(57) ABSTRACT

Embodiments of the present disclosure relate to method and apparatus for DCI payload size determination. According to some embodiments of the disclosure, a UE may: receive, from a BS, first signaling configuring a first set of cells for multi-cell scheduling by a DCI format; receive, from the BS, second signaling indicating that a first cell in the first set of cells is deactivated or dormant; determine a size of a first field specific for the first cell in the DCI format and a payload size of the DCI format; and receive, from the BS, the DCI format based on the determined payload size.

### TECHNICAL FIELD

Embodiments of the present disclosure generally relate to wireless communication technology, and more particularly to determining the payload size of a multi-cell scheduling downlink control information (DCI).

### BACKGROUND

A wireless communication system may include one or multiple network communication devices, such as base stations, which may support wireless communication for one or multiple user communication devices, which may be otherwise known as user equipment (UE), or other suitable terminology. The wireless communication system may support wireless communication with one or multiple user communication devices by utilizing resources of the wireless communication system (e.g., time resources (e.g., symbols, slots, subframes, frames, or the like)) or frequency resources (e.g., subcarriers, carriers, or the like). Additionally, the wireless communication system may support wireless communication across various radio access technologies including third generation (3G) radio access technology, fourth generation (4G) radio access technology, fifth generation (5G) (which is also known as new radio (NR)) radio access technology, among other suitable radio access technologies beyond 5G (e.g., sixth generation (6G)).

In a wireless communication system, a base station (BS) and a UE may communicate via downlink (DL) channels and uplink (UL) channels. For example, a UE may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH).

Carrier aggregation (CA) technology may be used in a wireless communication system to, for example, increase data rates. For example, CA technology may refer to aggregating spectrum resources (e.g., carriers or cells) from the same frequency band or different frequency bands. In a CA scenario, multiple cells may be configured for a UE and DL or UL channels may be carried on one or more of the multiple cells.

There is a need for determining the payload size of a multi-cell scheduling DCI in a wireless communication system.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some embodiments of the present disclosure provide a UE. The UE may include at least one memory; and at least one processor coupled with the at least one memory and configured to cause the UE to: receive, from a BS, first signaling configuring a first set of cells for multi-cell scheduling by a DCI format; receive, from the BS, second signaling indicating that a first cell in the first set of cells is deactivated or dormant; determine a size of a first field specific for the first cell in the DCI format and a payload size of the DCI format; and receive, from the BS, the DCI format based on the determined payload size.

In some embodiments, the size of the first field is set to 0.

In some embodiments, the processor is further configured to cause the UE to receive a list of co-scheduled cell combinations for the first set of cells, and the payload size of the DCI format is determined based on active bandwidth part(s) (BWP(s)) of activated cell(s) of co-scheduled cell combinations in the list of co-scheduled cell combinations. In some embodiments, in the case that the list of co-scheduled cell combinations is not configured for the UE, the payload size of the DCI format is determined based on active BWPs of all the activated cells in the first set of cells.

In some embodiments, the processor is further configured to cause the UE to receive a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

In some embodiments, the processor is further configured to cause the UE to receive a first configuration for the size of the first field.

In some embodiments, the processor is further configured to cause the UE to receive a first configuration for a total size of all fields specific for the first cell in the DCI format.

In some embodiments, the second signaling indicates that the first cell is dormant and the processor is further configured to cause the UE to receive a first configuration indicating a reference bandwidth for a dormant BWP of the first cell.

In some embodiments, the payload size of the DCI format is determined based on active BWPs of activated cells in the first set of cells, the reference bandwidth and a reference resource allocation type of the reference bandwidth.

In some embodiments, the first configuration further indicates a reference resource allocation type of the reference bandwidth. In some embodiments, a reference resource allocation type of the reference bandwidth is predefined.

In some embodiments, the second signaling indicates that the first cell is dormant and the processor is further configured to cause the UE to receive a first configuration indicating a reference BWP of the first cell.

In some embodiments, the payload size of the DCI format is determined based on active BWPs of activated cells in the first set of cells and the reference BWP of the first cell.

In some embodiments, the reference BWP is one of the following: a default BWP for the first cell; an initial BWP for the first cell; a first active BWP for the first cell; a first within-active-time BWP for the first cell; a first outside-active-time BWP for the first cell; a BWP with a smallest bandwidth among BWPs configured for the first cell; a BWP with a largest bandwidth among the BWPs configured for the first cell; and the latest active BWP of the first cell.

In some embodiments, the processor is further configured to cause the UE to receive a list of co-scheduled cell combinations for the first set of cells, and the payload size of the DCI format is determined based on active BWP(s) of activated cell(s) in the list of co-scheduled cell combinations and the first configuration. In some embodiments, in the case that the list of co-scheduled cell combinations for the first set of cells is not configured for the UE, the payload size of the DCI format is determined based on active BWPs of all the activated cells in the first set of cells and the first configuration.

In some embodiments, the processor is further configured to cause the UE to receive a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

Some embodiments of the present disclosure provide a BS. The BS may include at least one memory; and at least one processor coupled with the at least one memory and configured to cause the BS to: transmit, to a UE, first signaling configuring a first set of cells for the UE for multi-cell scheduling by a DCI format; transmit, to the UE, second signaling indicating that a first cell in the first set of cells is deactivated or dormant; determine a size of a first field specific for the first cell in the DCI format and a payload size of the DCI format; and transmit, to the UE, the DCI format based on the determined payload size.

In some embodiments, the size of the first field is set to 0.

In some embodiments, the processor is further configured to cause the BS to transmit, to the UE, a list of co-scheduled cell combinations for the first set of cells, and the payload size of the DCI format is determined based on active BWP(s) of activated cell(s) of co-scheduled cell combinations in the list of co-scheduled cell combinations. In some embodiments, in the case that the list of co-scheduled cell combinations is not configured for the UE, the payload size of the DCI format is determined based on active BWPs of all the activated cells in the first set of cells.

In some embodiments, the processor is further configured to cause the BS to transmit, to the UE, a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

In some embodiments, the processor is further configured to cause the BS to transmit, to the UE, a first configuration for the size of the first field.

In some embodiments, the processor is further configured to cause the BS to transmit, to the UE, a first configuration for a total size of all fields specific for the first cell in the DCI format.

In some embodiments, the second signaling indicates that the first cell is dormant and the processor is further configured to cause the BS to transmit, to the UE, a first configuration indicating a reference bandwidth for a dormant BWP of the first cell.

In some embodiments, the payload size of the DCI format is determined based on active BWPs of activated cells in the first set of cells, the reference bandwidth and a reference resource allocation type of the reference bandwidth.

In some embodiments, the first configuration further indicates a reference resource allocation type of the reference bandwidth. In some embodiments, a reference resource allocation type of the reference bandwidth is predefined.

In some embodiments, the second signaling indicates that the first cell is dormant and the processor is further configured to cause the BS to transmit, to the UE, a first configuration indicating a reference BWP of the first cell.

In some embodiments, the payload size of the DCI format is determined based on active BWPs of activated cells in the first set of cells and the reference BWP of the first cell.

In some embodiments, the reference BWP is one of the following: a default BWP for the first cell; an initial BWP for the first cell; a first active BWP for the first cell; a first within-active-time BWP for the first cell; a first outside-active-time BWP for the first cell; a BWP with a smallest bandwidth among BWPs configured for the first cell; a BWP with a largest bandwidth among the BWPs configured for the first cell; and the latest active BWP of the first cell.

In some embodiments, the processor is further configured to cause the BS to transmit, to the UE, a list of co-scheduled cell combinations for the first set of cells, and the payload size of the DCI format is determined based on active BWP(s) of activated cell(s) in the list of co-scheduled cell combinations and the first configuration. In some embodiments, in the case that the list of co-scheduled cell combinations for the first set of cells is not configured for the UE, the payload size of the DCI format is determined based on active BWPs of all the activated cells in the first set of cells and the first configuration.

In some embodiments, the processor is further configured to cause the BS to transmit, to the UE, a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

Some embodiments of the present disclosure provide a processor. The processor may include at least one controller coupled with at least one memory and configured to cause the processor to: receive, from a BS, first signaling configuring a first set of cells for multi-cell scheduling by a DCI format; receive, from the BS, second signaling indicating that a first cell in the first set of cells is deactivated or dormant; determine a size of a first field specific for the first cell in the DCI format and a payload size of the DCI format; and receive, from the BS, the DCI format based on the determined payload size.

Some embodiments of the present disclosure provide a processor. The processor may include at least one controller coupled with at least one memory and configured to cause the processor to: transmit, to a UE, first signaling configuring a first set of cells for the UE for multi-cell scheduling by a DCI format; transmit, to the UE, second signaling indicating that a first cell in the first set of cells is deactivated or dormant; determine a size of a first field specific for the first cell in the DCI format and a payload size of the DCI format; and transmit, to the UE, the DCI format based on the determined payload size.

Some embodiments of the present disclosure provide a method for wireless communication. The method may include: receiving, from a BS, first signaling configuring a first set of cells for multi-cell scheduling by a DCI format; receiving, from the BS, second signaling indicating that a first cell in the first set of cells is deactivated or dormant; determining a size of a first field specific for the first cell in the DCI format and a payload size of the DCI format; and receiving, from the BS, the DCI format based on the determined payload size.

Some embodiments of the present disclosure provide a method for wireless communication. The method may include: transmitting, to a UE, first signaling configuring a first set of cells for the UE for multi-cell scheduling by a DCI format; transmitting, to the UE, second signaling indicating that a first cell in the first set of cells is deactivated or dormant; determining a size of a first field specific for the first cell in the DCI format and a payload size of the DCI format; and transmitting, to the UE, the DCI format based on the determined payload size.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIGS. 2 and 3 illustrate flowcharts of methods for wireless communication in accordance with some embodiments of the present disclosure;

FIG. 4 illustrates an example of a UE in accordance with some embodiments of the present disclosure;

FIG. 5 illustrates an example of a processor in accordance with some embodiments of the present disclosure; and

FIG. 6 illustrates an example of a network equipment (NE) in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G NR or 6G, 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

A BS may configure a set of cells which can be used for multi-cell scheduling for a UE by a DCI format. If a cell of the set of configured cells is not activated, for example, is deactivated or indicated as dormant, it is unclear how to determine the size of a field specific for this cell in the DCI format or how to determine the entire payload size of the DCI format. If the payload size of the DCI format does not change even when a cell is deactivated or indicated as dormant, unnecessary resources may be consumed due to the large amount of resources required for a large payload size.

To solve the above issue, methods for determining the size of a field specific for this cell in the DCI format and methods for determining the payload size of a multi-cell scheduling DCI format are provided.

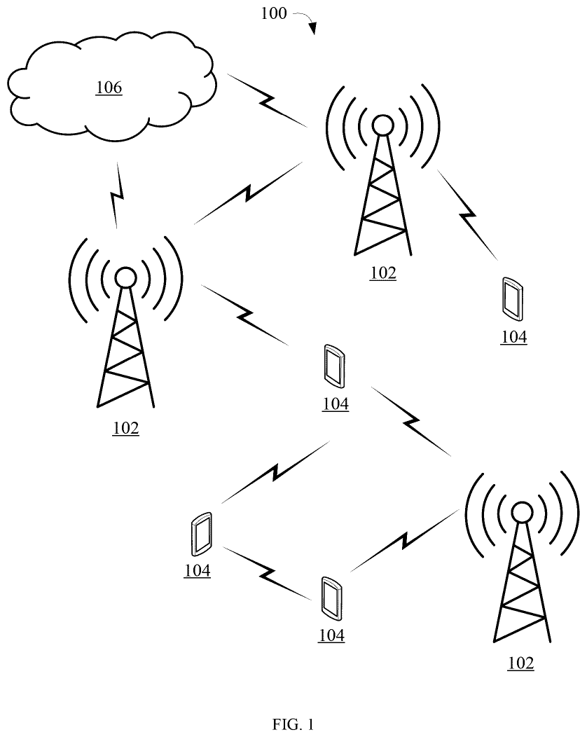

FIG. 1 illustrates a schematic diagram of wireless communication system 100 in accordance with some embodiments of the present disclosure.

The wireless communication system 100 may include one or more NEs 102 (e.g., one or more BSs), one or more UEs 104, and a core network (CN) 106. The wireless communication system 100 may support various radio access technologies. In some implementations, the wireless communication system 100 may be a 4G network, such as an LTE network or an LTE-Advanced (LTE-A) network. In some other implementations, the wireless communication system 100 may be a NR network, such as a 5G network, a 5G-Advanced (5G-A) network, or a 5G ultra-wideband (5G-UWB) network. In other implementations, the wireless communication system 100 may be a combination of a 4G network and a 5G network, or other suitable radio access technology including Institute of Electrical and Electronics Engineers (IEEE) 802.11 (Wi-Fi), IEEE 802.16 (WiMAX), and IEEE 802.20. The wireless communication system 100 may support radio access technologies beyond 5G, for example, 6G. Additionally, the wireless communication system 100 may support technologies, such as time division multiple access (TDMA), frequency division multiple access (FDMA), or code division multiple access (CDMA), etc.

The one or more NEs 102 may be dispersed throughout a geographic region to form the wireless communication system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with a different NE 102.

The one or more UEs 104 may be dispersed throughout a geographic region of the wireless communication system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communication with the CN 106, or with another NE 102, or both. For example, an NE 102 may interface with another NE 102 or the CN 106 through one or more backhaul links (e.g., S1, N2, N3 or another network interface). In some implementations, the NE 102 may communicate with each other directly. In some other implementations, the NE 102 may communicate with each other or indirectly (e.g., via the CN 106. In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management (AMF)) functions and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communication system 100, the NEs 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communication). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communication system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix. A sixth numerology (e.g., μ=5) may be associated with a sixth subcarrier spacing (e.g., 480 kHz) and a normal cyclic prefix. A seventh numerology (e.g., μ=6) may be associated with a seventh subcarrier spacing (e.g., 960 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communication system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communication system 100, an electromagnetic (EM) spectrum may be split, based on frequency or wavelength, into various classes, frequency bands, frequency channels, etc. By way of example, the wireless communication system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communication over one or more of the operating frequency bands. In some implementations, FR1 may be used by the NEs 102 and the UEs 104, among other equipment or devices for cellular communication traffic (e.g., control information, data). In some implementations, FR2 may be used by the NEs 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A UE 104 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, a UE 104 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, a UE 104 includes wearable devices, such as smart watches, fitness bands, optical head-mounted displays, or the like. Moreover, a UE 104 may be referred to as a subscriber unit, a mobile, a mobile station, a user, a terminal, a mobile terminal, a wireless terminal, a fixed terminal, a subscriber station, a user terminal, or a device, or described using other terminology used in the art. A UE 104 may communicate with an NE 102 (e.g., a BS) via uplink (UL) communication signals. An NE 102 may communicate with a UE 104 via downlink (DL) communication signals.

In some embodiments of the present disclosure, an NE 102 and a UE 104 may communicate over licensed spectrums, whereas in some other embodiments, an NE 102 and a UE 104 may communicate over unlicensed spectrums. The present disclosure is not intended to be limited to the implementation of any particular wireless communication system architecture or protocol.

In some embodiments of the present disclosure, the wireless communication system 100 may be designed to support CA. To reduce signaling overhead in the case of CA, multi-cell data transmission (e.g., physical uplink shared channel (PUSCH) or physical downlink shared channel (PDSCH)) scheduling with a single scheduling DCI format is supported and is referred to as multi-cell scheduling in the context of the present disclosure. For example, a dedicated UL DCI format (e.g., DCI format 0_3) may be introduced for scheduling up to 4 PUSCHs on 4 cells with each PUSCH per cell. For example, a dedicated DL DCI format (e.g., DCI format 1_3) may be introduced for scheduling up to 4 PDSCHs on 4 cells with each PDSCH per cell.

For example, in some embodiments of the present disclosure, a BS may configure a set of cells which can be used for multi-cell scheduling for a UE. For example, the BS may transmit a DCI format to the UE, and the DCI format may schedule one or more downlink data transmissions (e.g., PDSCHs) or uplink data transmissions (e.g., PUSCHs) on one or more cells in the configured cell set.

In some embodiments, a cell may be deactivated or switched to a dormant BWP. The dormant BWP may be configured by the network for a cell via dedicated RRC signaling as one of the downlink BWPs of the cell. In the dormant BWP, the UE may stop monitoring the PDCCH on or for the cell, but may continue performing channel state information (CSI) measurements, automatic gain control (AGC) and beam management, if configured. When a cell is deactivated, the UE may stop monitoring the PDCCH on or for the cell and stop performing CSI measurements, automatic gain control (AGC) and beam management, if configured. Entering or leaving dormant BWP of a cell (e.g., a secondary cell (SCell)) is done by BWP switching per SCell or per dormancy SCell group based on instruction from a PDCCH. The dormancy SCell group configurations can be configured by RRC signaling. In response to the reception of the PDCCH indicating leaving the dormant BWP, a preconfigured DL BWP is activated. Upon reception of the PDCCH indicating entering a dormant BWP, the dormant BWP is activated.

If a cell of the set of configured cells is deactivated or indicated as dormant, it is unclear how to determine the size of a field specific for this cell (e.g., a frequency domain resource assignment (FDRA) field) in the DCI format or how to determine the entire payload size of the DCI format. If the payload size of the DCI format does not change even when a cell is deactivated or indicated as dormant, unnecessary resources (e.g., control channel element (CCE) resources) may be consumed due to the large amount of resources required for a large payload size.

Embodiments of the present disclosure provides various solutions to solve the above issues. For example, methods for determining the payload size of a multi-cell scheduling DCI format are provided. More details on the embodiments of the present disclosure will be illustrated in the following text in combination with the appended drawings.

In some embodiments of the present disclosure, a BS may configure, for a UE, a set of cells (denoted as cell set #1 for clarity) for multi-cell scheduling by a DCI format. The DCI format can be, for example, DCI format 1_3 or DCI format 0_3. For example, a BS may transmit signaling configuring cell set #1 for the UE. The BS and the UE may determine the size of a cell-specific field in the DCI format and a payload size of the DCI format according to the following embodiments. The BS may transmit the DCI format based on the determined payload size. The UE may receive, from the BS, the DCI format based on the determined payload size.

In some embodiments of the present disclosure, in the case that the BS transmits signaling indicating a cell (denoted as cell #A for clarity) in cell set #1 is deactivated or dormant, the size of each cell-specific field corresponding to cell #A in the DCI format is set to 0. When determining the total payload size of the DCI format, the size of the cell-specific field(s) for cell #A is not taken into account.

In the context of the present disclosure, a cell-specific field for a cell in a DCI format may include, but not limited to, the following: a FDRA field, a modulation and coding scheme (MCS) field, a new data indicator (NDI) field, a redundancy version (RV) field, a hybrid automatic repeat request (HARQ) process number field or an antenna port field if configured as the cell-specific type (also referred to as Type 2); a field indicating precoding information and the number of layers if configured as cell-specific type (i.e., Type 2), and a field indicating phase tracking reference signal (PTRS) and demodulation reference signal (DMRS) association. According to the above embodiments, when calculating the total payload size of the DCI format, the above cell-specific fields of a deactivated or dormant cell are not considered. In other words, these cell-specific fields of the deactivated or dormant cell are excluded from the DCI format.

In some embodiments, the UE may receive, from the BS, a list of co-scheduled cell combinations for cell set #1 (e.g., via radio resource control (RRC) signaling). The payload size of the DCI format can be determined based on active BWP(s) of activated cell(s) of co-scheduled cell combinations in the list of co-scheduled cell combinations. That is, the payload size of the DCI format does not take into account the deactivated or dormant cell(s). For example, the payload size of the DCI format can be derived based on the RRC configuration of the active BWP(s) of the activated cell(s) of the co-scheduled cell combinations in the list of co-scheduled cell combinations, without considering the deactivated or dormant cell(s).

In some embodiments, the payload size of the DCI format may be the same for the active BWP(s) of the activated cell(s) of all the co-scheduled cell combinations in the list of co-scheduled cell combinations, and may be based on (e.g., equal to) the largest payload size among the active BWP(s) of all the co-scheduled cell combinations in the list of co-scheduled cell combinations. For example, for each co-scheduled cell combination, a corresponding payload size can be determined based on the RRC configuration of the active BWP(s) of the activated cell(s) in the co-scheduled cell combination (i.e., not considering the deactivated or dormant cell(s) therein). The final payload size of the DCI format is the largest payload size among the determined payload sizes of all co-scheduled cell combinations in the list of co-scheduled cell combinations.

In some embodiments, in the case that the list of co-scheduled cell combinations is not configured for the UE, the payload size of the DCI format can be determined based on active BWPs of all the activated cells in cell set #1. That is, the payload size of the DCI format does not take into account the deactivated or dormant cell(s). For example, the payload size of the DCI format can be derived based on the RRC configuration of the active BWPs of all the activated cells in cell set #1, without considering the deactivated or dormant cell(s).

In some embodiments of the present disclosure, in the case that the BS transmits signaling indicating a cell (denoted as cell #B for clarity) in cell set #1 is deactivated or dormant, the size of each cell-specific field corresponding to cell #B in the DCI format may be determined based on a configuration (denoted as configuration #B for clarity) from the BS. That is, the BS may transmit configuration #B indicating the size of a cell-specific field for cell #B. Configuration #B may be transmitted via RRC signaling and may indicate one of the following values for a cell-specific field: 0, 1, 2, 3, 4, 8, 12, and 16. In some embodiments, the size of a cell-specific field for cell #B may be determined based on the size of this field when cell #B is activated. In some embodiments, the size of each cell-specific field for cell #B may be separately configured. When calculating the total payload size of the DCI format, the corresponding RRC configured sizes (i.e., configuration #B) are used for the cell-specific fields for a deactivated or dormant cell.

For example, the payload size of the DCI format can be determined based on an RRC configuration of the active BWPs of the activated cells in cell set #1 and the RRC configured size (e.g., configuration #B) of each cell-specific field of the deactivated or dormant cell in cell set #1. When calculating the total payload size of the DCI format, the cell-specific fields of the deactivated or dormant cell are taken into account, i.e., by using configuration #B.

In some embodiments, the UE may receive, from the BS, a list of co-scheduled cell combinations for cell set #1 (e.g., via RRC signaling). The payload size of the DCI format can be determined based on active BWP(s) of activated cell(s) of co-scheduled cell combinations in the list of co-scheduled cell combinations and configuration #B. That is, the payload size of the DCI format takes into account the deactivated or dormant cell(s). For example, the payload size of the DCI format can be derived based on the RRC configuration of the active BWP(s) of the activated cell(s) of the co-scheduled cell combinations in the list of co-scheduled cell combinations and configuration #B.

In some embodiments, the payload size of the DCI format may be the same for the active BWP(s) of the activated cell(s) of all the co-scheduled cell combinations in the list of co-scheduled cell combinations, and may be based on (e.g., equal to) the largest payload size among the active BWP(s) of all the co-scheduled cell combinations in the list of co-scheduled cell combinations. For example, for each co-scheduled cell combination, a corresponding payload size can be determined based on the RRC configuration of the active BWP(s) of the activated cell(s) in the co-scheduled cell combination and configuration #B for a deactivated or dormant cell(s) in the co-scheduled cell combination (if any). The final payload size of the DCI format is the largest payload size among the determined payload sizes of all co-scheduled cell combinations in the list of co-scheduled cell combinations.

In some embodiments, in the case that the list of co-scheduled cell combinations is not configured for the UE, the payload size of the DCI format can be determined based on active BWPs of all the activated cells in cell set #1 and configuration #B. That is, the payload size of the DCI format takes into account the deactivated or dormant cell(s). For example, the payload size of the DCI format can be derived based on the RRC configuration of the active BWPs of all the activated cells in cell set #1, and configuration #B for a deactivated or dormant cell(s) (if any) in cell set #1.

In some embodiments of the present disclosure, in the case that the BS transmits signaling indicating a cell (denoted as cell #C for clarity) in cell set #1 is deactivated or dormant, a total size of all cell-specific fields corresponding to cell #C in the DCI format may be determined based on a configuration (denoted as configuration #C for clarity) from the BS. That is, the BS may transmit configuration #C indicating the total size of all cell-specific fields for cell #C. Configuration #C may be transmitted via RRC signaling and may indicate one of the following values for a cell: 0, 4, 8, 12, 16, 20, 24, 28, and 32. In some embodiments, the total size for cell #C may be determined based on the sizes of the cell-specific fields for cell #C when cell #C is activated. When calculating the total payload size of the DCI format, configuration #C is used for the cell-specific fields for a deactivated or dormant cell.

For example, the payload size of the DCI format can be determined based on an RRC configuration of the active BWPs of the activated cells in cell set #1 and the RRC configured size (e.g., configuration #C) of each deactivated or dormant cell in cell set #1. When calculating the total payload size of the DCI format, the cell-specific fields of the deactivated or dormant cell are taken into account, i.e., by using configuration #C.

In some embodiments, the UE may receive, from the BS, a list of co-scheduled cell combinations for cell set #1 (e.g., via RRC signaling). The payload size of the DCI format can be determined based on active BWP(s) of activated cell(s) of co-scheduled cell combinations in the list of co-scheduled cell combinations and configuration #C. That is, the payload size of the DCI format takes into account the deactivated or dormant cell(s). For example, the payload size of the DCI format can be derived based on the RRC configuration of the active BWP(s) of the activated cell(s) of the co-scheduled cell combinations in the list of co-scheduled cell combinations and configuration #C.

In some embodiments, the payload size of the DCI format may be the same for the active BWP(s) of the activated cell(s) of all the co-scheduled cell combinations in the list of co-scheduled cell combinations, and may be based on (e.g., equal to) the largest payload size among the active BWP(s) of all the co-scheduled cell combinations in the list of co-scheduled cell combinations. For example, for each co-scheduled cell combination, a corresponding payload size can be determined based on the RRC configuration of the active BWP(s) of the activated cell(s) in the co-scheduled cell combination and configuration #C for a deactivated or dormant cell(s) in the co-scheduled cell combination (if any). The final payload size of the DCI format is the largest payload size among the determined payload sizes of all co-scheduled cell combinations in the list of co-scheduled cell combinations.

In some embodiments, in the case that the list of co-scheduled cell combinations is not configured for the UE, the payload size of the DCI format can be determined based on active BWPs of all the activated cells in cell set #1 and configuration #C. That is, the payload size of the DCI format takes into account the deactivated or dormant cell(s). For example, the payload size of the DCI format can be derived based on the RRC configuration of the active BWPs of all the activated cells in cell set #1, and configuration #C for a deactivated or dormant cell(s) (if any) in cell set #1.

In some embodiments of the present disclosure, in the case that the BS transmits signaling indicating a cell (denoted as cell #D for clarity) in cell set #1 is dormant, a reference bandwidth for the dormant BWP of cell #D may be configured (denoted as configuration #D for clarity). That is, the BS may transmit configuration #D indicating the reference bandwidth for the dormant BWP of cell #D. In some other embodiments, the reference bandwidth may be predefined (e.g., in a standard(s)).

The configured reference bandwidth can be used to determine the size of a cell-specific field corresponding to cell #D in the DCI format. For example, the number of bits of the FDRA field for cell #D can be determined based on the configured reference bandwidth. Field sizes of other cell-specific fields for cell #D, such as MCS, NDI, RV, HARQ process number, antenna port if configured as cell-specific type (i.e., Type 2), transmit power control (TPC) command for scheduled PUSCH, sounding reference signal (SRS) resource indicator if configured as the cell-specific type (i.e., Type 2), precoding information and number of layers if configured as the cell-specific type (i.e., Type 2), and PTRS-DMRS association can be determined without relying on the dormant BWP and by using, for example, various methods known to persons skilled in the art.

In some embodiments, configuration #D may further include a reference resource allocation type of the reference bandwidth. The UE can determine the number of bits of the FDRA field of cell #D based on the reference bandwidth and the reference resource allocation type. In some embodiments, the reference allocation type for the reference bandwidth may be predefined (e.g., in a standard(s)). For example, the reference allocation type may be predefined as resource allocation type 0 or resource allocation type 1. The specific definitions of various resource allocation types can be found in 3GPP specifications.

For example, the payload size of the DCI format can be determined based on an RRC configuration of the active BWPs of the activated cells in cell set #1 and configuration #D of each dormant cell (i.e., the reference bandwidth and reference resource allocation type for the dormant BWP of the dormant cell) in cell set #1. That is, when calculating the total payload size of the DCI format, the cell-specific fields of the dormant cell are taken into account, i.e., by using configuration #D.

In some embodiments, the UE may receive, from the BS, a list of co-scheduled cell combinations for cell set #1 (e.g., via RRC signaling). The payload size of the DCI format can be determined based on active BWP(s) of activated cell(s) of co-scheduled cell combinations in the list of co-scheduled cell combinations and configuration #D. That is, the payload size of the DCI format takes into account the dormant cell(s). For example, the payload size of the DCI format can be derived based on the RRC configuration of the active BWP(s) of the activated cell(s) of the co-scheduled cell combinations in the list of co-scheduled cell combinations and configuration #D.

In some embodiments, the payload size of the DCI format may be the same for the active BWP(s) of the activated cell(s) of all the co-scheduled cell combinations in the list of co-scheduled cell combinations, and may be based on (e.g., equal to) the largest payload size among the active BWP(s) of all the co-scheduled cell combinations in the list of co-scheduled cell combinations. For example, for each co-scheduled cell combination, a corresponding payload size can be determined based on the RRC configuration of the active BWP(s) of the activated cell(s) in the co-scheduled cell combination and configuration #D for a dormant cell(s) in the co-scheduled cell combination (if any). The final payload size of the DCI format is the largest payload size among the determined payload sizes of all co-scheduled cell combinations in the list of co-scheduled cell combinations.

In some embodiments, in the case that the list of co-scheduled cell combinations is not configured for the UE, the payload size of the DCI format can be determined based on active BWPs of all the activated cells in cell set #1 and configuration #D. That is, the payload size of the DCI format takes into account the dormant cell(s). For example, the payload size of the DCI format can be derived based on the RRC configuration of the active BWPs of all the activated cells in cell set #1 and configuration #D for the dormant cell(s) (if any) in cell set #1.

In some embodiments of the present disclosure, in the case that the BS transmits signaling indicating a cell (denoted as cell #E for clarity) in cell set #1 is dormant, a reference BWP of cell #E may be configured (denoted as configuration #E for clarity). That is, the BS may transmit configuration #E indicating a reference BWP for cell #E. In some other embodiments, the reference BWP may be predefined (e.g., in a standard(s)).

The configured reference BWP can be used to determine the size of a cell-specific field corresponding to cell #E in the DCI format. For example, the number of bits of the FDRA field for cell #E can be determined based on the configured reference BWP. Field sizes of other cell-specific fields for cell #E, such as MCS, NDI, RV, HARQ process number, antenna port if configured as cell-specific type (i.e., Type 2), TPC command for scheduled PUSCH, SRS resource indicator if configured as the cell-specific type (i.e., Type 2), precoding information and number of layers if configured as the cell-specific type (i.e., Type 2), and PTRS-DMRS association can be determined without relying on the dormant BWP or the reference BWP and by using, for example, various methods known to persons skilled in the art.

The reference BWP may be one of the following: a default BWP for cell #E; the initial BWP for cell #E; the first active BWP for cell #E; the first within-active-time BWP (e.g., the BWP indicated by “firstWithinActiveTimeBWP” as specified in 3GPP specification) for cell #E; a first outside-active-time BWP (e.g., the BWP indicated by “firstOutsideActiveTimeBWP” as specified in 3GPP specification) for cell #E; a BWP with the smallest bandwidth among BWPs configured for cell #E; a BWP with the largest bandwidth among the BWPs configured for cell #E; and the latest active BWP of cell #E. When the reference BWP is the latest active BWP of cell #E, the payload size of the DCI format does not change in response to cell #E being indicated as dormant.

For example, the payload size of the DCI format can be determined based on an RRC configuration of the active BWPs of the activated cells in cell set #1 and configuration #E of each dormant cell (i.e., the reference BWP of the dormant cell) in cell set #1. That is, when calculating the total payload size of the DCI format, the cell-specific fields of the dormant cell are taken into account, i.e., by using configuration #E.

In some embodiments, the UE may receive, from the BS, a list of co-scheduled cell combinations for cell set #1 (e.g., via RRC signaling). The payload size of the DCI format can be determined based on active BWP(s) of activated cell(s) of co-scheduled cell combinations in the list of co-scheduled cell combinations and configuration #E. That is, the payload size of the DCI format takes into account the dormant cell(s). For example, the payload size of the DCI format can be derived based on the RRC configuration of the active BWP(s) of the activated cell(s) of the co-scheduled cell combinations in the list of co-scheduled cell combinations and configuration #E.

In some embodiments, the payload size of the DCI format may be the same for the active BWP(s) of the activated cell(s) of all the co-scheduled cell combinations in the list of co-scheduled cell combinations, and may be based on (e.g., equal to) the largest payload size among the active BWP(s) of all the co-scheduled cell combinations in the list of co-scheduled cell combinations. For example, for each co-scheduled cell combination, a corresponding payload size can be determined based on the RRC configuration of the active BWP(s) of the activated cell(s) in the co-scheduled cell combination and configuration #E for a dormant cell(s) in the co-scheduled cell combination (if any). The final payload size of the DCI format is the largest payload size among the determined payload sizes of all co-scheduled cell combinations in the list of co-scheduled cell combinations.

In some embodiments, in the case that the list of co-scheduled cell combinations is not configured for the UE, the payload size of the DCI format can be determined based on active BWPs of all the activated cells in cell set #1 and configuration #E. That is, the payload size of the DCI format takes into account the dormant cell(s). For example, the payload size of the DCI format can be derived based on the RRC configuration of the active BWPs of all the activated cells in cell set #1 and configuration #E for the dormant cell(s) (if any) in cell set #1.

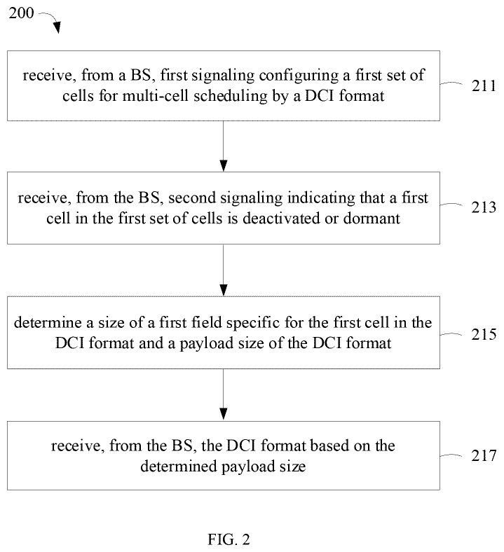

FIG. 2 illustrates a flowchart of method 200 for wireless communication in accordance with some embodiments of the present disclosure. Details described in all of the foregoing embodiments of the present disclosure are applicable for the embodiments shown in FIG. 2. In some examples, method 200 may be performed by a UE, for example, UE 104 as described with reference to FIG. 1. In some embodiments, the UE may execute a set of instructions to control the functional elements of the UE to perform the described functions or operations. In some examples, a processor of a UE may cause the UE to perform method 200.

At 211, a UE may receive, from a BS, first signaling configuring a first set of cells for multi-cell scheduling by a DCI format. At 213, the UE may receive, from the BS, second signaling indicating that a first cell in the first set of cells is deactivated or dormant. At 215, the UE may determine a size of a first field specific for the first cell in the DCI format and a payload size of the DCI format. At 217, the UE may receive, from the BS, the DCI format based on the determined payload size.

In some embodiments, the size of the first field is set to 0.

In some embodiments, the UE may receive a list of co-scheduled cell combinations for the first set of cells. The payload size of the DCI format is determined based on active BWP(s) of activated cell(s) of co-scheduled cell combinations in the list of co-scheduled cell combinations. In some embodiments, in the case that the list of co-scheduled cell combinations is not configured for the UE, the payload size of the DCI format is determined based on active BWPs of all the activated cells in the first set of cells.

In some embodiments, the UE may receive a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

In some embodiments, the UE may receive a first configuration for the size of the first field.

In some embodiments, the UE may receive a first configuration for a total size of all fields specific for the first cell in the DCI format.

In some embodiments, the second signaling indicates that the first cell is dormant. The UE may receive a first configuration indicating a reference bandwidth for a dormant BWP of the first cell.

In some embodiments, the payload size of the DCI format is determined based on active BWPs of activated cells in the first set of cells, the reference bandwidth and a reference resource allocation type of the reference bandwidth.

In some embodiments, the first configuration further indicates a reference resource allocation type of the reference bandwidth. In some embodiments, a reference resource allocation type of the reference bandwidth is predefined.

In some embodiments, the second signaling indicates that the first cell is dormant. The UE may receive a first configuration indicating a reference BWP of the first cell.

In some embodiments, the payload size of the DCI format is determined based on active BWPs of activated cells in the first set of cells and the reference BWP of the first cell.

In some embodiments, the reference BWP is one of the following: a default BWP for the first cell; an initial BWP for the first cell; a first active BWP for the first cell; a first within-active-time BWP for the first cell; a first outside-active-time BWP for the first cell; a BWP with a smallest bandwidth among BWPs configured for the first cell; a BWP with a largest bandwidth among the BWPs configured for the first cell; and the latest active BWP of the first cell.

In some embodiments, the UE may receive a list of co-scheduled cell combinations for the first set of cells. The payload size of the DCI format is determined based on active BWP(s) of activated cell(s) in the list of co-scheduled cell combinations and the first configuration. In some embodiments, in the case that the list of co-scheduled cell combinations for the first set of cells is not configured for the UE, the payload size of the DCI format is determined based on active BWPs of all the activated cells in the first set of cells and the first configuration.

In some embodiments, the UE may receive a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

It should be appreciated by persons skilled in the art that the sequence of the operations in exemplary method 200 may be changed and some of the operations in exemplary method 200 may be eliminated or modified, without departing from the spirit and scope of the disclosure.

FIG. 3 illustrates a flowchart of method 300 for wireless communication in accordance with some embodiments of the present disclosure. Details described in all of the foregoing embodiments of the present disclosure are applicable for the embodiments shown in FIG. 3. In some examples, method 300 may be performed by a BS or an NE (for example, NE 102 as described with reference to FIG. 1). In some embodiments, the BS or the NE may execute a set of instructions to control the functional elements of the BS or the NE to perform the described functions or operations. In some examples, a processor of an NE may cause the NE to perform method 300.

At 311, a BS may transmit, to a UE, first signaling configuring a first set of cells for the UE for multi-cell scheduling by a DCI format. At 313, the BS may transmit, to the UE, second signaling indicating that a first cell in the first set of cells is deactivated or dormant. At 315, the BS may determine a size of a first field specific for the first cell in the DCI format and a payload size of the DCI format. At 317, the BS may and transmit, to the UE, the DCI format based on the determined payload size.

In some embodiments, the size of the first field is set to 0.

In some embodiments, the BS may transmit, to the UE, a list of co-scheduled cell combinations for the first set of cells. The payload size of the DCI format is determined based on active BWP(s) of activated cell(s) of co-scheduled cell combinations in the list of co-scheduled cell combinations. In some embodiments, in the case that the list of co-scheduled cell combinations is not configured for the UE, the payload size of the DCI format is determined based on active BWPs of all the activated cells in the first set of cells.

In some embodiments, the BS may transmit, to the UE, a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

In some embodiments, the BS may transmit, to the UE, a first configuration for the size of the first field.

In some embodiments, the BS may transmit, to the UE, a first configuration for a total size of all fields specific for the first cell in the DCI format.

In some embodiments, the second signaling indicates that the first cell is dormant. The BS may transmit, to the UE, a first configuration indicating a reference bandwidth for a dormant BWP of the first cell.

In some embodiments, the payload size of the DCI format is determined based on active BWPs of activated cells in the first set of cells, the reference bandwidth and a reference resource allocation type of the reference bandwidth.

In some embodiments, the first configuration further indicates a reference resource allocation type of the reference bandwidth. In some embodiments, a reference resource allocation type of the reference bandwidth is predefined.

In some embodiments, the second signaling indicates that the first cell is dormant. The BS may transmit, to the UE, a first configuration indicating a reference BWP of the first cell.

In some embodiments, the payload size of the DCI format is determined based on active BWPs of activated cells in the first set of cells and the reference BWP of the first cell.

In some embodiments, the reference BWP is one of the following: a default BWP for the first cell; an initial BWP for the first cell; a first active BWP for the first cell; a first within-active-time BWP for the first cell; a first outside-active-time BWP for the first cell; a BWP with a smallest bandwidth among BWPs configured for the first cell; a BWP with a largest bandwidth among the BWPs configured for the first cell; and the latest active BWP of the first cell.

In some embodiments, the BS may transmit, to the UE, a list of co-scheduled cell combinations for the first set of cells. The payload size of the DCI format is determined based on active BWP(s) of activated cell(s) in the list of co-scheduled cell combinations and the first configuration. In some embodiments, in the case that the list of co-scheduled cell combinations for the first set of cells is not configured for the UE, the payload size of the DCI format is determined based on active BWPs of all the activated cells in the first set of cells and the first configuration.

In some embodiments, the BS may transmit, to the UE, a list of co-scheduled cell combinations for the first set of cells. In some embodiments, the payload size of the DCI format is the same for active BWP(s) of activated cell(s) of all the co-scheduled cell combinations in the list of co-scheduled cell combinations, and is based on a largest payload size among the active BWP(s) of all the co-scheduled cell combinations in the list of co-scheduled cell combinations.

It should be appreciated by persons skilled in the art that the sequence of the operations in exemplary method 300 may be changed and some of the operations in exemplary method 300 may be eliminated or modified, without departing from the spirit and scope of the disclosure.

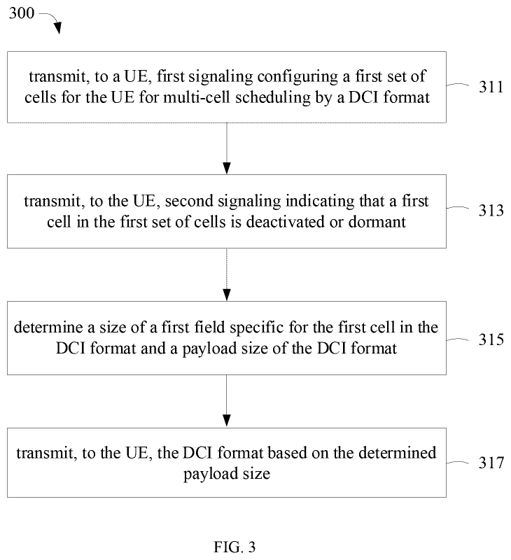

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. For example, the UE 400 may be configured to support means for performing the operations as described with respect to FIG. 2.

For example, the UE 400 may be configured to support: a means for receiving, from a BS, first signaling configuring a first set of cells for multi-cell scheduling by a DCI format; a means for receiving, from the BS, second signaling indicating that a first cell in the first set of cells is deactivated or dormant; a means for determining a size of a first field specific for the first cell in the DCI format and a payload size of the DCI format; and a means for receiving, from the BS, the DCI format based on the determined payload size.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, or packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, or packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

It should be appreciated by persons skilled in the art that the components in exemplary UE 400 may be changed, for example, some of the components in exemplary UE 400 may be omitted or modified or a new component(s) may be added to exemplary UE 400, without departing from the spirit and scope of the disclosure. For example, in some embodiments, the UE 400 may not include the controller 406.

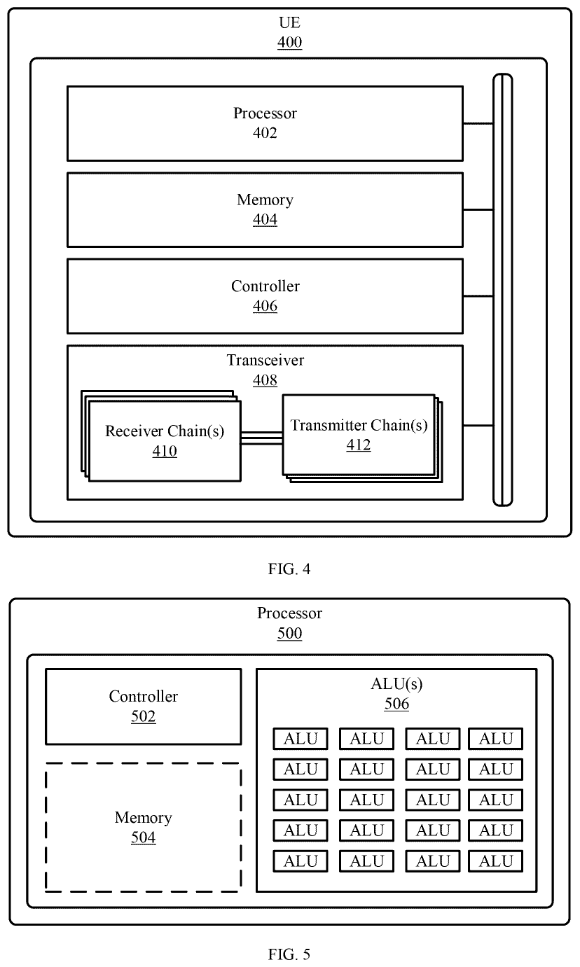

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine a subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, ALUs, and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein.

For example, the processor 500 may be configured to support means for performing the operations as described with respect to FIG. 2. For example, the processor 500 may be configured to or operable to support: a means for receiving, from a BS, first signaling configuring a first set of cells for multi-cell scheduling by a DCI format; a means for receiving, from the BS, second signaling indicating that a first cell in the first set of cells is deactivated or dormant; a means for determining a size of a first field specific for the first cell in the DCI format and a payload size of the DCI format; and a means for receiving, from the BS, the DCI format based on the determined payload size.

For example, the processor 500 may be configured to support means for performing the operations as described with respect to FIG. 3. For example, the processor 500 may be configured to or operable to support: a means for transmitting, to a UE, first signaling configuring a first set of cells for the UE for multi-cell scheduling by a DCI format; a means for transmitting, to the UE, second signaling indicating that a first cell in the first set of cells is deactivated or dormant; a means for determining a size of a first field specific for the first cell in the DCI format and a payload size of the DCI format; and a means for transmitting, to the UE, the DCI format based on the determined payload size.

It should be appreciated by persons skilled in the art that the components in exemplary processor 500 may be changed, for example, some of the components in exemplary processor 500 may be omitted or modified or a new component(s) may be added to exemplary processor 500, without departing from the spirit and scope of the disclosure. For example, in some embodiments, the processor 500 may not include the ALUs 506.

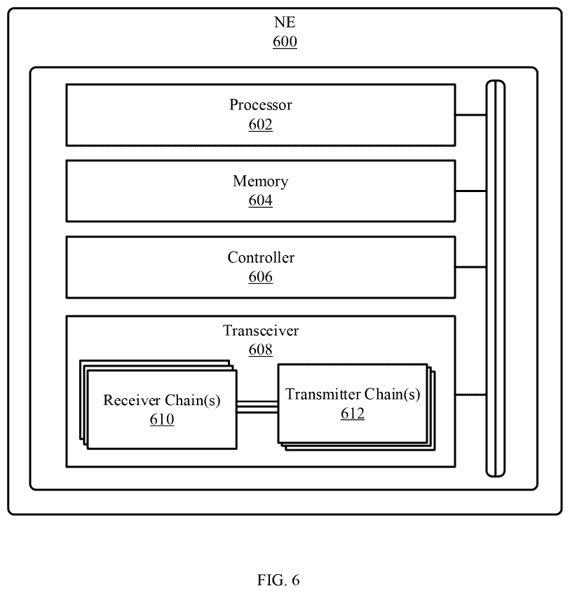

FIG. 6 illustrates an example of an NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. For example, the NE 600 may be configured to support means for performing the operations as described with respect to FIG. 3.

For example, the NE 600 may be configured to support: a means for transmitting, to a UE, first signaling configuring a first set of cells for the UE for multi-cell scheduling by a DCI format; a means for transmitting, to the UE, second signaling indicating that a first cell in the first set of cells is deactivated or dormant; a means for determining a size of a first field specific for the first cell in the DCI format and a payload size of the DCI format; and a means for transmitting, to the UE, the DCI format based on the determined payload size.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, or packets) over a wireless medium. For example, the receiver chain 610 may include one or more antennas for receive the signal over the air or wireless medium. The receiver chain 610 may include at least one amplifier (e.g., an LNA) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, or packets). The transmitter chain 612may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

It should be appreciated by persons skilled in the art that the components in exemplary NE 600 may be changed, for example, some of the components in exemplary NE 600 may be omitted or modified or a new component(s) may be added to exemplary NE 600, without departing from the spirit and scope of the disclosure. For example, in some embodiments, the NE 600 may not include the controller 606.

Those having ordinary skill in the art would understand that the operations or steps of the methods described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of the methods may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. The disclosure is not limited to the examples and designs described herein but is to be accorded with the broadest scope consistent with the principles and novel features disclosed herein. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” or the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
receive, from a base station (BS), first signaling configuring a first set of cells for multi-cell scheduling by a downlink control information (DCI) format;
receive, from the BS, second signaling indicating that a first cell in the first set of cells is deactivated or dormant;
determine a size of a first field specific for the first cell in the DCI format and a payload size of the DCI format; and
receive, from the BS, the DCI format based on the determined payload size.

2. The UE of claim 1, wherein the size of the first field is set to 0.

3. The UE of claim 2, wherein the at least one processor is further configured to cause the UE to receive a list of co-scheduled cell combinations for the first set of cells, and the payload size of the DCI format is determined based on active bandwidth parts (BWPs) of activated cells of co-scheduled cell combinations in the list of co-scheduled cell combinations; or
wherein, when the list of co-scheduled cell combinations is not configured for the UE, the payload size of the DCI format is determined based on active BWPs of all the activated cells in the first set of cells.

4. The UE of claim 2, wherein the at least one processor is further configured to cause the UE to receive a list of co-scheduled cell combinations for the first set of cells; and
wherein the payload size of the DCI format is the same for active bandwidth parts (BWPs) of activated cells of all the co-scheduled cell combinations in the list of co-scheduled cell combinations, and is based on a largest payload size among the active BWPs of all the co-scheduled cell combinations in the list of co-scheduled cell combinations.

5. The UE of claim 1, wherein the at least one processor is further configured to cause the UE to receive a first configuration for the size of the first field.

6. The UE of claim 1, wherein the at least one processor is further configured to cause the UE to receive a first configuration for a total size of all fields specific for the first cell in the DCI format.

7. The UE of claim 1, wherein the second signaling indicates that the first cell is dormant, and wherein the at least one processor is further configured to cause the UE to receive a first configuration indicating a reference bandwidth for a dormant bandwidth part (BWP) of the first cell.

8. The UE of claim 7, wherein the payload size of the DCI format is determined based on active BWPs of activated cells in the first set of cells, the reference bandwidth, and a reference resource allocation type of the reference bandwidth.

9. The UE of claim 1, wherein the second signaling indicates that the first cell is dormant, and wherein the at least one processor is further configured to cause the UE to receive a first configuration indicating a reference bandwidth part (BWP) of the first cell.

10. The UE of claim 9, wherein the payload size of the DCI format is determined based on active BWPs of activated cells in the first set of cells and the reference BWP of the first cell.

11. The UE of claim 10, wherein the reference BWP includes:
a default BWP for the first cell;
an initial BWP for the first cell;
a first active BWP for the first cell;
a first within-active-time BWP for the first cell;
a first outside-active-time BWP for the first cell;
a BWP with a smallest bandwidth among BWPs configured for the first cell;
a BWP with a largest bandwidth among the BWPs configured for the first cell; or
the latest active BWP of the first cell.

12. The UE of claim 10, wherein the at least one processor is further configured to cause the UE to receive a list of co-scheduled cell combinations for the first set of cells, and the payload size of the DCI format is determined based on active bandwidth parts (BWPs) of activated cells in the list of co-scheduled cell combinations and the first configuration; or
wherein, when the list of co-scheduled cell combinations for the first set of cells is not configured for the UE, the payload size of the DCI format is determined based on active BWPs of all the activated cells in the first set of cells and the first configuration.

13. The UE of claim 10, wherein the at least one processor is further configured to cause the UE to receive a list of co-scheduled cell combinations for the first set of cells; and
wherein the payload size of the DCI format is the same for active bandwidth parts (BWPs) of activated cells of all the co-scheduled cell combinations in the list of co-scheduled cell combinations, and is based on a largest payload size among the active BWPs of all the co-scheduled cell combinations in the list of co-scheduled cell combinations.

14. A base station (BS) for wireless communication, comprising:
at least one memory; and
at least one processor coupled with the at least one memory and configured to cause the BS to:
transmit, to a user equipment (UE), first signaling configuring a first set of cells for the UE for multi-cell scheduling by a downlink control information (DCI) format;
transmit, to the UE, second signaling indicating that a first cell in the first set of cells is deactivated or dormant;
determine a size of a first field specific for the first cell in the DCI format and a payload size of the DCI format; and
transmit, to the UE, the DCI format based on the determined payload size.

15. The BS of claim 14, wherein the size of the first field is set to 0.

16. The BS of claim 14, wherein the at least one processor is further configured to cause the BS to transmit, to the UE, a first configuration for the size of the first field.

17. The BS of claim 14, wherein the second signaling indicates that the first cell is dormant, and wherein the at least one processor is further configured to cause the BS to transmit, to the UE, a first configuration indicating a reference bandwidth for a dormant bandwidth part (BWP) of the first cell.

18. The BS of claim 14, wherein the second signaling indicates that the first cell is dormant, and wherein the at least one processor is further configured to cause the BS to transmit, to the UE, a first configuration indicating a reference bandwidth part (BWP) of the first cell.

19. A processor for wireless communication, comprising:
at least one controller coupled with at least one memory and configured to cause the processor to:
receive, from a base station (BS), first signaling configuring a first set of cells for multi-cell scheduling by a downlink control information (DCI) format;
receive, from the BS, second signaling indicating that a first cell in the first set of cells is deactivated or dormant;
determine a size of a first field specific for the first cell in the DCI format and a payload size of the DCI format; and
receive, from the BS, the DCI format based on the determined payload size.

20. A method performed by a user equipment (UE), the method comprising:
receiving, from a base station (BS), first signaling configuring a first set of cells for multi-cell scheduling by a downlink control information (DCI) format;
receiving, from the BS, second signaling indicating that a first cell in the first set of cells is deactivated or dormant;
determining a size of a first field specific for the first cell in the DCI format and a payload size of the DCI format; and
receiving, from the BS, the DCI format based on the determined payload size.
